(19) United States
(12) Patent Application Publication
(10) Pub. No.: US 2004/0040425 A1
(43) Pub. Date: Mar. 4, 2004

(54) Method and apparatus for cutting sheet metal

(75) Inventors: Friedrich Peyerl, Albuquerque, NM (US); Robert Timothy DeBlassie, Albuquerque, NM (US); David Saenz Alvarez, Albuquerque, NM (US)

Correspondence Address: DAVID E. CRAWFORD, JR., SONNENSCHEIN NATH & ROSENTHAL, 8000 SEARS TOWER, CHICAGO, IL, 60606, US

(73) Assignee: General Electric Company

(21) Appl. No.: 10/231,861

(22) Filed: Aug. 30, 2002

(51) Int. Cl. B26D 3/00; B27B 9/02; B27B 19/14; B27B 21/08

(52) U.S. Cl. 83/56; 30/376

(57) ABSTRACT

A method for cutting sheet material including positioning the material on an upper surface of a guide table having slots. A blade of a saw is aligned with one of the slots and the saw is energized. The blade is advanced through the sheet material with the blade in the slot to cut the material along a line corresponding to the slot. Apparatus for cutting sheet material is also disclosed. The apparatus includes a saw and a guide table including an upper surface having a plurality of elongate slots therein for receiving the saw blade to guide the saw along the surface.

### BACKGROUND OF THE INVENTION

The present invention relates generally to a method and apparatus for cutting sheets of material such as uncured epoxy foam material.

Often, composite components such as those used in gas turbine engines are made by stacking sheets of material in predetermined orientations. The individual stacked sheets or laminae are activated to bond them together to form the composite components. Frequently, the sheets of material are made of a foam or film epoxy material having paper backing covering each face prior to use.

Conventionally, a knife and a straight edge are used to cut the sheet material to desired sizes and shapes prior to stacking them. However, as the sheets are cut, the technician simultaneously must hold the straight edge in place on the sheet material, hold the knife against the straight edge and press the knife against the sheet material with sufficient force to cut the material. If the knife becomes spaced from the straight edge or the straight edge moves, the cut will not be straight. Further, this procedure sometimes produces slivers of the material, slivers of the paper backing, and/or slivers of the straight edge. If the slivers are not found and removed, they can become embedded in the components. In addition, as the material becomes thicker, this conventional method becomes more difficult.

Another conventional method and apparatus for cutting sheet material is a wire cutter including a table for receiving the material having a tensioned wire laying in a slot and a shuttle for guiding the wire upward through the material thereby cutting the material. However, the adhesive properties of the sheet material cause the material to adhere to the wire and the shuttle mechanism thereby reducing their effectiveness. Further, as the material thickness increases, there is an increased likelihood of the wire breaking, causing a need for maintenance.

Sometimes when the sheets are stacked, they become misaligned. Thus, stacking the sheets before cutting them may be desirable. However, stacking the sheets makes the material thicker thereby making the material more difficult to cut.

### SUMMARY OF THE INVENTION

The present invention includes a method for cutting sheet material comprising positioning the sheet material on an upper surface of a guide table having a plurality of slots. A blade of a saw is aligned with a first slot in the guide table. The saw is energized to actuate the blade of the saw and the blade is advanced through the sheet material while maintaining the blade in the slot to cut the material along a line corresponding to the slot.

In another aspect, the present invention includes a saw for cutting sheet material comprising a body and a motor mounted inside the body having an energized state and a de-energized state. Further, the saw includes a blade adapted for cutting the sheet material connected to the motor so that the blade moves with respect to the body when the motor is in the energized state and a base plate mounted on the body for slidably engaging the sheet material as the blade cuts the sheet material. The plate has a lower surface covered with polytetrafluoroethylene for reducing friction between the base plate and the sheet material as the plate slidably engages the sheet material.

In yet another aspect, the present invention includes apparatus for cutting sheet material comprising a saw having a blade adapted for cutting the sheet material and a guide table including an upper surface for receiving the sheet material. The surface has a plurality of elongate slots therein for receiving the saw blade to guide the saw along the surface. Each of the slots has a uniform and equal width greater than a kerf of the saw blade, a length at least as great as a length of cut for the sheet material, and a height sufficient to accommodate at least a portion of the saw blade when the sheet material is received by the upper surface of the guide table and the saw engages the sheet material.

Other features of the present invention will be in part apparent and in part pointed out hereinafter.

### BRIEF DESCRIPTION OF THE DRAWINGS

FIG. 1 is a rear elevation of a guide table and a saw of the present invention shown cutting sheet material positioned on top of the guide table;

FIG. 2 is a top plan of the guide table having a sheet of material thereon;

FIG. 3 is a side elevation of the guide table and the saw shown cutting a sheet of material; and

FIG. 4 is a side elevation of a blade used in the saw of the present invention.

Corresponding reference characters indicate corresponding parts throughout the several views of the drawings.

### DETAILED DESCRIPTION OF THE PREFERRED EMBODIMENT

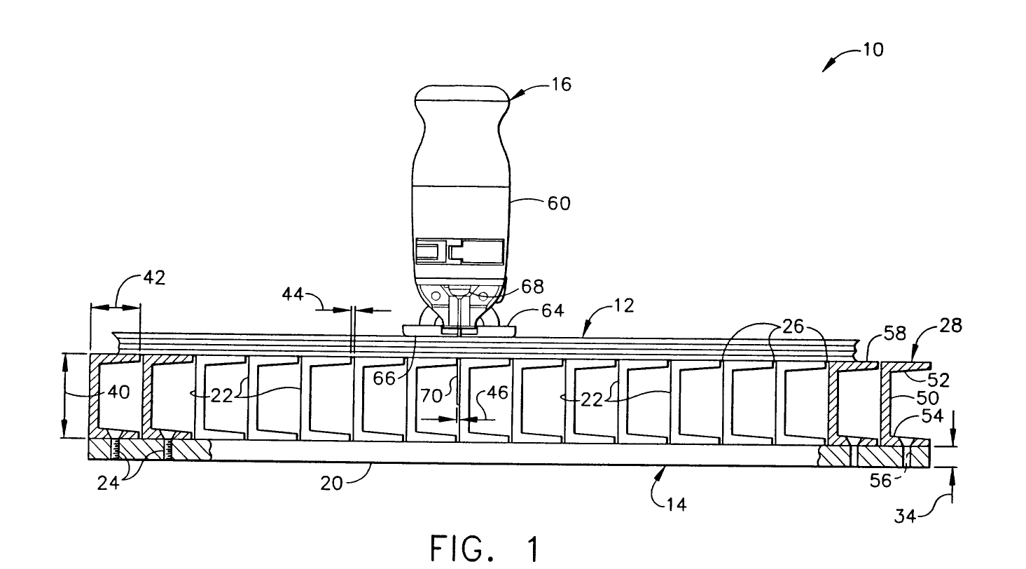

Referring now to the drawings and in particular to FIG. 1, apparatus of the present invention is designated in its entirety by the reference number 10. The apparatus is intended for cutting sheet material, generally designated by 12. The apparatus 10 comprises a guide table, generally designated by 14, and a saw, generally designated by 16.

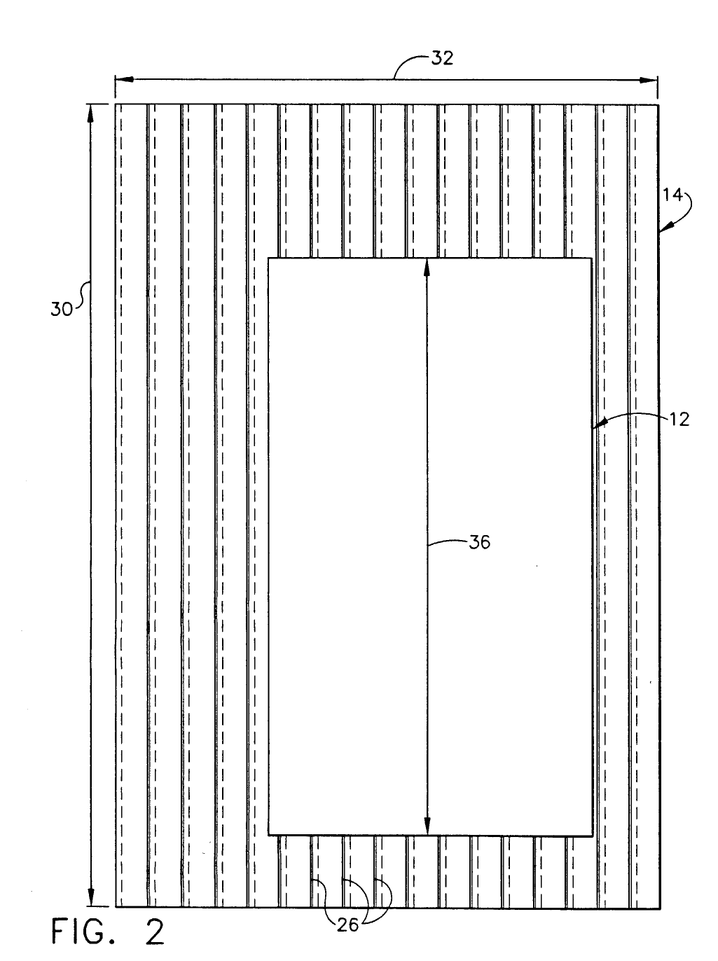

The guide table 14 comprises a base 20 and a series of C-channels 22 fastened to the base with screw fasteners 24 (e.g., ¼-20 flathead machine screws threaded into tapped holes in the base). The channels 22 are uniformly spaced by elongate slots 26 which extend parallel to each other and are equally spaced across an upper surface, generally designated by 28, of the guide table 14. Although the base 20 and channels 22 may be made of other materials without departing from the scope of the present invention, in one embodiment they are made of 6061-T6 aluminum. Further, although the base 20 may have other dimensions without departing from the scope of the present invention, in one embodiment the base has a length 30 (FIG. 2) of about 30 inches, a width 32 (FIG. 2) of about 19.93 inches and a thickness 34 of about 0.50 inch. Preferably, the length 30 of the base 20 matches that of the table 14 and is at least as great as a length 36 of cut for the sheet material 12 as shown in FIG. 2. As further illustrated in FIG. 1, although the channels 22 may have other dimensions without departing from the scope of the present invention, in one embodiment each channel has a height 40 of about 2.00 inches and a width 42 of about 1.18 inch. Each of the slots 26 has a width 44 greater than a kerf 46 of the saw 16. In one embodiment, each of the slots 26 has a width 44 of about 0.07 inch. In an alternate embodiment (not shown), the channels 22 have progressively wider widths 42. For example, each channel 22 may have a width 42 that is 0.125 inch wider than the adjacent channel so the slot 26 spacing progressively increases by 0.125 inch. This arrangement permits the guide table 14 to be used to cut sheet material 12 into pieces having different widths without moving the material between cuts.

As illustrated in FIG. 1, each of the channels 22 includes a vertical web 50, an upper flange 52 extending laterally from an upper end of the web, and a lower flange 54 extending laterally from a lower end of the web opposite the upper end. The screw fasteners 24 mounting the channels 22 to the base 20 extend through holes 56 in the lower flange. Each of the upper flanges 52 has a top surface 58. Collectively, these top surfaces 58 form the upper surface 28 of the table 14.

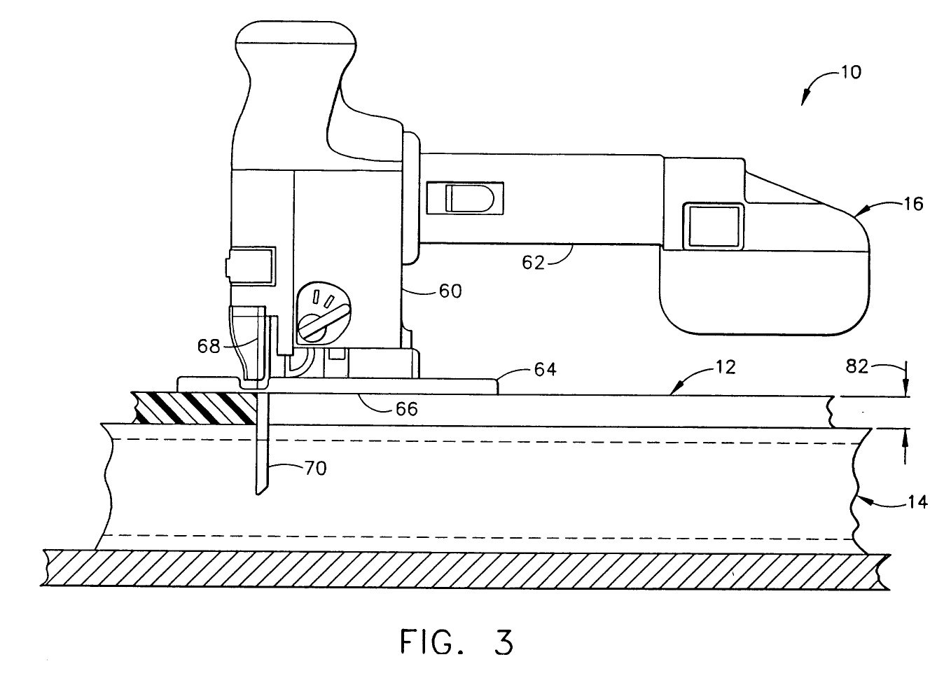

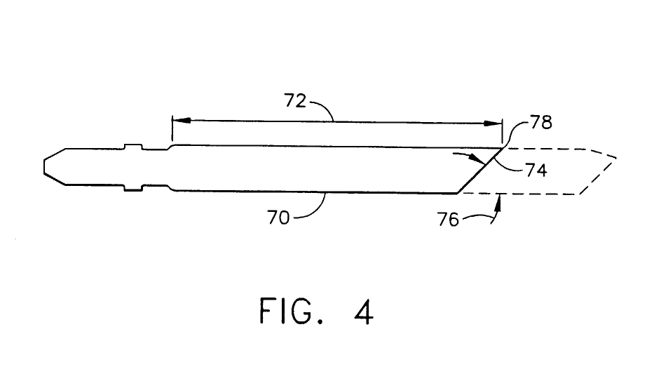

As illustrated in FIG. 3, the saw 16 is a conventional reciprocating saw such as a 2.0 amp, 24 watt saw sold under the trade name Power Plus by Milwaukee Electric Tool Corporation of Brookfield Wis. The saw 16 includes a housing 60, a handle 62 and a base plate 64. A lower surface 66 of the plate 64 is treated to reduce friction between the surface 66 and the sheet material 12 being cut. In one embodiment, polytetrafluoroethylene impregnated tape (e.g., Teflon® tape) is applied to the lower surface 66 to prevent the plate 64 from sticking to the material. A conventional motor (not shown) mounted inside the housing 60 is attached to a chuck 68 adapted for releasably mounting a blade 70 to the saw 16 so the blade extends downward through the base plate 64. The motor may be energized to reciprocate the blade 70 in a direction perpendicular to the lower surface 66 of the base plate 64. Although other blades may be used without departing from the scope of the present invention, in one embodiment the blade 70 is a model number VA-6004 blade sold by Milwaukee Electric Tool Corporation. The blade 70 is modified by cutting it to length. In one embodiment, the blade 70 is modified as shown in FIG. 4 to have a working blade length 72 of between about 2.15 inches and about 2.25 inches. Further, a lower end 74 of the blade 70 is cut at an angle 76 of between about 40 degrees and about 60 degrees to provide a sharp point 78. As will be appreciated by those skilled in the art, each slot 26 in the table 14 has a depth corresponding to the height 40 of the channels 22. Preferably, each slot 26 has a depth sufficient to accommodate at least a portion of the saw blade 70 when the sheet material 12 is received by the upper surface 28 of the guide table 14 and the saw 16 engages the sheet material.

In one embodiment, the sheet of material 12 comprises a plurality of sheets or laminae 80 stacked atop each other. Preferably, the stacked laminae 80 produce a sheet 12 having the desired uniform thickness 82. Further, as will be appreciate by those skilled in the art, the cutting length 72 of the blade 70 preferably is greater than the thickness 82 of the sheet 12. Prior to stacking the laminae, a paper backing (not shown) is removed from each of the sheets except on the top surface of the upper most sheet and the bottom surface of the lower most sheet. The laminated sheet material 12 is positioned on the table 14 so one of the slots 26 of the table is immediately below a place on the sheet material where a cut is desired. Once in position, the sheet material 12 is fastened in place on the table 14 with tape or the like (not shown) . The saw 16 is positioned above the table 14 so the base plate 64 rests on the top surface 82 of the material 12 and the blade 70 extends downward through the selected slot 26 where the cut is to be made. The saw 16 is energized to reciprocate the blade 70 and the operator advances the saw so the blade travels along the slot 26 and cuts the material 12 along a straight line corresponding to the slot. After each cut, resulting pieces of material may be removed before the saw 16 is indexed to the next slot 26 where a cut is desired and the process is repeated.

The method and apparatus described above provide several advantages over previous methods for cutting sheet material. First, the method allows for cutting sheet material in uniform pieces of desired dimensions having even edges. In contrast, previous methods often resulted in pieces having uneven edges. The polytetrafluoroethylene base plate of the saw allows for the saw to advance smoothly over the material without becoming stuck. Furthermore, the slots in the guide table ensure that the cut made by the saw is in a straight line.

In view of the above, it will be seen that the several objects of the invention are achieved and other advantageous results attained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A method for cutting sheet material comprising the steps of:
positioning the sheet material on an upper surface of a guide table having a plurality of slots therein;
aligning a blade of a saw with a first slot of said plurality of slots in the guide table;
energizing the saw to actuate the blade of the saw; and
advancing the blade through the sheet material while maintaining the blade in said first slot in the guide table thereby cutting the material along a line corresponding to said first slot.

2. A method as set forth in claim 1 further comprising repeating the aligning, energizing, and advancing steps at a second slot of said plurality of slots.

3. A method as set forth in claim 1 wherein the sheet material comprises a plurality of laminae and the method further comprises the step of stacking said plurality of laminae prior to positioning the material on the guide table.

4. A method as set forth in claim 1 further comprising the step of attaching the positioned sheet material to the upper surface of the guide table.

5. A method as set forth in claim 1 further comprising the step of removing cut pieces of sheet material from the guide table after the blade is advanced through the material.

6. A saw for cutting sheet material comprising:
a body;
a motor mounted inside the body having an energized state and a de-energized state;
a blade adapted for cutting the sheet material connected to the motor so that the blade moves with respect to the body when the motor is in the energized state; and
a base plate mounted on the body for slidably engaging the sheet material as the blade cuts the sheet material, the plate having a lower surface covered with polytetrafluoroethylene for reducing friction between the base plate and the sheet material as the plate slidably engages the sheet material.

7. A saw as set forth in claim 6 wherein the blade reciprocates generally perpendicular to the lower surface of the base plate when the motor is in the energized state.

8. A saw as set forth in claim 7 wherein the sheet material has a uniform predetermined thickness and the blade has a cutting length greater than said predetermined thickness of the sheet material.

9. A saw as set forth in claim 6 wherein said lower surface of the base plate is covered with strips of a polytetrafluoroethylene impregnated adhesive backed tape.

10. Apparatus for cutting sheet material comprising:
a saw having a blade adapted for cutting said sheet material; and
a guide table including an upper surface for receiving the sheet material, said surface having a plurality of elongate slots therein for receiving the saw blade to guide the saw along the surface, each of said slots having a uniform and equal width greater than a kerf of the saw blade, a length at least as great as a length of cut for the sheet material, and a depth sufficient to accommodate at least a portion of the saw blade when the sheet material is received by the upper surface of the guide table and the saw engages the sheet material.

11. Apparatus as set forth in claim 10 wherein the guide table comprises a base and a plurality of elongate elements mounted on the base, each of the elements including a top surface collectively forming said upper surface of the table.

12. Apparatus as set forth in claim 10 wherein each of said elements includes a vertical web, a upper flange extending laterally from an upper end of the web, and a lower flange extending laterally from a lower end of the web opposite the upper end.

13. Apparatus as set forth in claim 12 wherein each of the elements is a C-channel.

14. Apparatus as set forth in claim 12 wherein the lower flange of each element is fastened to the base member with a screw fastener.

15. Apparatus as set forth in claim 10 wherein said elongate slots are parallel.

16. Apparatus as set forth in claim 10 wherein said elongate slots are equally spaced.

17. Apparatus as set forth in claim 10 wherein the saw includes a base plate having a lower surface covered with polytetrafluoroethylene for reducing friction between the base plate and the sheet material as the plate slidably engages the sheet material.
